(19) United States
(12) Patent Application Publication
(10) Pub. No.: US 2008/0130169 A1
(43) Pub. Date: Jun. 5, 2008

(54) SPINDLE MOTOR AND DISK DEVICE PROVIDED WITH THE SAME

(75) Inventor: Hiroyuki Kitamura, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/946,624

(22) Filed: Nov. 28, 2007

(30) Foreign Application Priority Data
Nov. 30, 2006 (JP) 2006-324799

(51) Int. Cl. H02K 11/00; G11B 17/02; H02K 7/08

(52) U.S. Cl. 360/99.08; 310/217; 310/90

(57) ABSTRACT

According to one embodiment, a disk device includes a recording medium, a spindle motor which supports and rotates the recording medium, a head, and a head actuator which supports the head for movement. The spindle motor includes a rotor, a fluid bearing which supports the rotor for rotation, a cylindrical magnet coaxially fixed to the rotor, an annular stator located outside the rotor in the circumferential direction, and a magnetic shielding member which blocks leakage flux from a magnetic circuit. The magnetic shielding member has an annular portion which extends at right angles to an axis of rotation of the rotor and covers an upper surface portion of the stator, and a cylindrical portion which extends along the axis of rotation of the rotor and radially faces the whole outer peripheral surface of the rotor except a region where the stator and the magnet face each other.

### CROSS-REFERENCE TO RELATED APPLICATIONS

This application is based upon and claims the benefit of priority from Japanese Patent Application No. 2006-324799, filed Nov. 30, 2006, the entire contents of which are incorporated herein by reference.

### BACKGROUND

1. Field

One embodiment of the invention relates to a spindle motor and a disk device provided with the spindle motor and a disk for use as a recording medium.

2. Description of the Related Art

In recent years, disk devices, such as magnetic disk devices, optical disk devices, etc., have been widely used as external recording devices of computers or image or music recording/reproducing apparatuses.

A disk device, e.g., a magnetic disk device, generally includes a magnetic disk, spindle motor, head actuator, voice coil motor, circuit board unit, etc. The magnetic disk is disposed in a housing. The spindle motor supports and rotates the disk. The head actuator supports magnetic heads. The voice coil motor serves to drive the actuator. The head actuator is provided with a bearing portion and arms that are laminated on and extend from the bearing portion. A magnetic head is mounted on each arm by means of a suspension.

In general, a spindle motor of an inner-rotor type includes, for example, a rotor, which is rotatably supported by a fluid bearing, and an annular stator provided on a base of the housing and opposed to the periphery of the rotor. By way of example, the rotor includes a permanent magnet having a plurality of magnetic poles, while the stator includes a plurality of magnetic poles each formed of a core and a coil wound thereon. The magnetic poles of the stator are arranged at regular intervals in the circumferential direction around the rotor. A spindle motor described in, for example, Jpn. Pat. Appln. KOKAI Publication No. 2005-160202, moreover, includes a flat annular shielding plate that serves to block leakage flux from the stator. The flat shielding plate covers an upper surface portion of the stator.

In recent years, disk devices have been used as, for example, recording devices of on-board equipment with the advance of diversification of application, increasingly demanding a reduction in size. Many spindle motors used in disk devices employ fluid bearings. Based on structural requirements, oil is used as a fluid for the bearings. The viscosity of bearing oil varies depending on the working environment of a spindle motor and considerably influences the properties of the motor. Thus, it is very hard for the spindle motor of this type to attain a required cold-start temperature range for the on-board equipment. This problem becomes more definite with a reduction in motor size that imposes restrictions on space.

In consideration of use in the low-temperature environment, it is considered effective, for example, to increase the size of a magnet that constitutes a magnetic circuit, thereby enhancing the torque of the spindle motor. If this is done, however, magnetic circuit components are exposed to the interior of the disk device. In this case, the conventional flat shielding plate that is configured to cover the upper surface of the stator cannot fully block leakage flux from the magnetic circuit with ease. If the leakage flux is blocked only inadequately, a failure may occur, such as a loss of recorded data in the disk.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing the internal structure of an HDD according to a first embodiment of the invention;

FIG. 2 is an exemplary sectional view showing a spindle motor section of the HDD;

FIG. 3 is an exemplary exploded perspective view showing a stator and a magnetic shielding plate of the spindle motor;

FIG. 4 is an exemplary sectional view showing a spindle motor section of an HDD according to a second embodiment of the invention;

FIG. 5 is an exemplary sectional view showing a spindle motor section of an HDD according to a third embodiment of the invention;

FIG. 6 is an exemplary sectional view showing a spindle motor section of an HDD according to a fourth embodiment of the invention;

FIG. 7 is an exemplary sectional view showing a spindle motor section of an HDD according to a fifth embodiment of the invention;

FIG. 8 is an exemplary sectional view showing a spindle motor section of an HDD according to a sixth embodiment of the invention; and

FIG. 9 is an exemplary sectional view showing a spindle motor section of an HDD according to another embodiment of the invention.

### DETAILED DESCRIPTION

Various embodiments according to the invention will be described hereinafter with reference to the accompanying drawings. In general, according to one embodiment of the invention, there is provided a spindle motor comprising: a rotor; a fluid bearing which is provided on a base and supports the rotor for rotation; a cylindrical magnet coaxially fixed to the rotor, exposed on an outer peripheral surface of the rotor, and having a plurality of magnetic poles arranged side by side in a circumferential direction; an annular stator fixed to the base, located outside the rotor in the circumferential direction, and having a plurality of magnetic poles opposed to the magnet of the rotor; and a magnetic shielding member which blocks leakage flux from a magnetic circuit, the magnetic shielding member including an annular portion which extends at right angles to an axis of rotation of the rotor and covers an upper surface portion of the stator and a cylindrical portion which extends along the axis of rotation of the rotor and radially faces the whole outer peripheral surface of the rotor except a region where the stator and the magnet face each other.

According to another embodiment of the invention, there is provided a disk device comprising: a housing including a base; a disk-shaped recording medium arranged in the housing; a spindle motor which is provided on the base and supports and rotates the recording medium; a head which records and reproduces information to and from the recording medium; and a head actuator which is disposed in the housing, supports the head for movement, and moves the head with respect to the recording medium, the spindle motor including a rotor, a fluid bearing which is provided on the base and supports the rotor for rotation, a cylindrical magnet coaxially fixed to the rotor, exposed on an outer peripheral surface of the rotor, and having a plurality of magnetic poles arranged side by side in a circumferential direction, an annular stator fixed to the base, located outside the rotor in the circumferential direction, and having a plurality of magnetic poles opposed to the magnet of the rotor, and a magnetic shielding member which blocks leakage flux from a magnetic circuit, the magnetic shielding member including an annular portion which extends at right angles to an axis of rotation of the rotor and covers an upper surface portion of the stator and a cylindrical portion which extends along the axis of rotation of the rotor and radially faces the whole outer peripheral surface of the rotor except a region where the stator and the magnet face each other.

A first embodiment in which a disk device of this invention is applied to a hard disk drive (HDD) will now be described in detail with reference to the accompanying drawings.

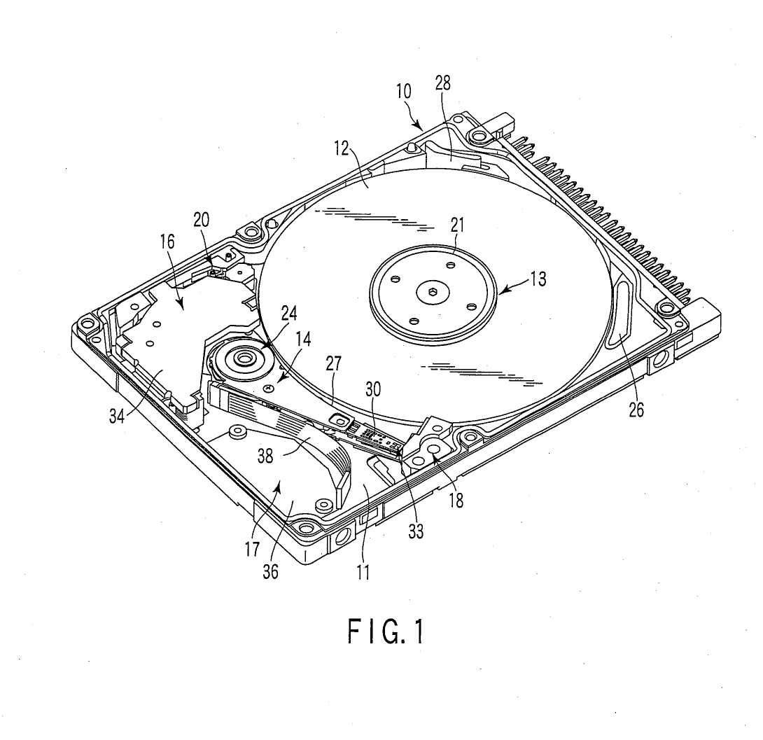

FIG. 1 shows the internal structure of the HDD with its top cover off. As shown in FIG. 1, the HDD is provided with a housing 10. The housing 10 includes a base 11 in the form of an open-topped rectangular box and the top cover (not shown) in the form of a rectangular plate. The top cover is fastened to the base by screws so as to close a top opening of the base. Thus, the interior of the housing 10 is kept airtight, and ventilation to the outside can be achieved only through the breathing filter 26. The base 11 and the top cover are formed of aluminum or steel, for example.

Arranged on the base 11 are a magnetic disk 12, a spindle motor 13, magnetic heads 33, e.g., two in number, a head actuator 14, and a voice coil motor (VCM) 16. The spindle motor 13 supports and rotates the magnetic disk for use as a recording medium. The heads 33 serve to record and reproduce information to and from the disk. The head actuator 14 supports the heads 33 for movement with respect to a surface of the disk 12. The VCM 16 serves to rock and position the actuator. Further arranged on the base 11 are a ramp load mechanism 18, an inertia latch mechanism 20, and a board unit 17. The ramp load mechanism 18 holds the magnetic heads 33 in a position at a distance from the magnetic disk 12 when the heads are moved to the outermost periphery of the disk. The inertia latch mechanism 20 serves to hold the head actuator 14 in a retracted position if a shock or the like acts on the HDD. Electronic components, including a preamplifier and the like, are mounted on the board unit 17.

A printed circuit board (not shown) for controlling the operations of the spindle motor 13, VCM 16, and magnetic heads 33 through the board unit 17 is screwed to the outer surface of the base 11 so as to face the bottom wall of the base 11.

The magnetic disk 12 is formed having a diameter of, for example, 2.5 inches and provided with magnetic recording layers on its upper and lower surfaces, individually. The disk 12 is coaxially fitted on a hub (mentioned later) of the spindle motor 13 and clamped by a clamp spring 21 that is screwed to the upper end of the hub, whereby the disk 12 is fixed to the hub. The disk 12 is rotated at a predetermined speed, e.g., 4,200 rpm, by the spindle motor 13 for use as a drive motor.

The head actuator 14 is provided with a bearing assembly 24 fixed on the bottom wall of the base 11. The bearing assembly 24, which functions as a bearing portion, includes a pivot set up on the bottom wall of the base 11 and a cylindrical hub that is rotatably supported on the pivot by means of a pair of bearings. The head actuator 14 is provided with two arms 27 mounted on the hub of the bearing assembly, two suspensions 30 extending individually from the arms, and the magnetic heads 33 supported individually on the respective extended ends of the suspensions.

Each magnetic head 33 includes a substantially rectangular slider (not shown) and a magnetoresistive (MR) head element formed on the slider. It is fixed to a gimbals portion that is formed on the distal end portion of its corresponding suspension 30. Each head 33 is electrically connected to a main FPC 38 (mentioned later) by a relay flexible printed circuit board (not shown).

The board unit 17 is formed of a flexible printed circuit board (FPC) and includes an FPC body 36 and the main FPC 38. The FPC body 36 is fixed on the bottom surface of the base 11 and mounted with electronic components. The main FPC 38 extends from the FPC body.

The two arms 27 are arranged parallel to each other with a predetermined space between them. The suspensions 30 and the magnetic heads 33 that are mounted on these arms are opposed to one another with the magnetic disk 12 between them. The VCM 16 includes a support frame (not shown), which extends from the bearing assembly 24 on the side opposite from the arms 27, and a voice coil supported on the support frame. When the head actuator 14 is incorporated in the base 11, the voice coil is situated between a pair of yokes 34 fixed on the base 11 and, along with the yokes and a magnet fixed to one of the yokes, constitutes the VCM 16.

If the voice coil is energized with the magnetic disk 12 in rotation, the head actuator 14 rocks, whereupon the magnetic heads 33 are moved onto desired tracks of the disk 12 and positioned there. As this is done, the heads 33 are moved radially across the disk 12 between the inner and outer peripheral edge portions of the disk. One of the magnetic heads 33 moves within the space between one surface of the disk 12 and the top cover, while the other head 33 moves within the space between the other surface of the disk and the bottom surface of the base 11.

The following is a detailed description of the spindle motor 13.

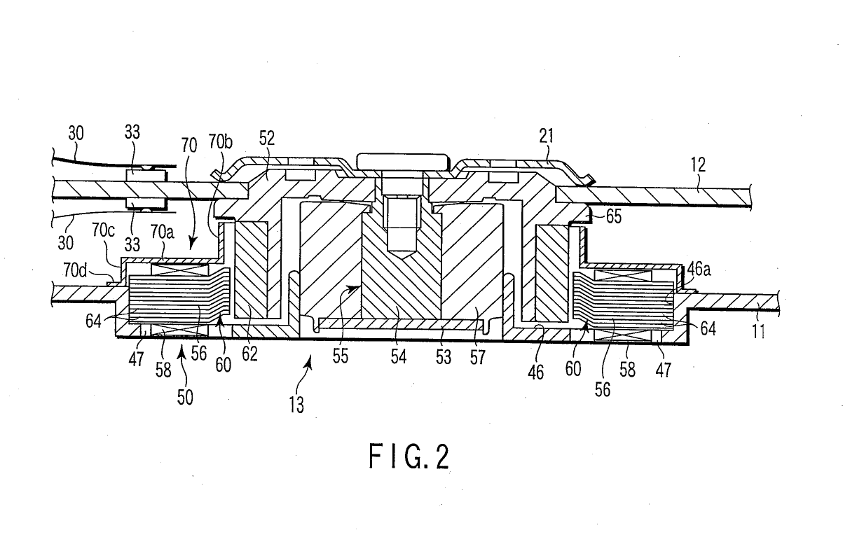

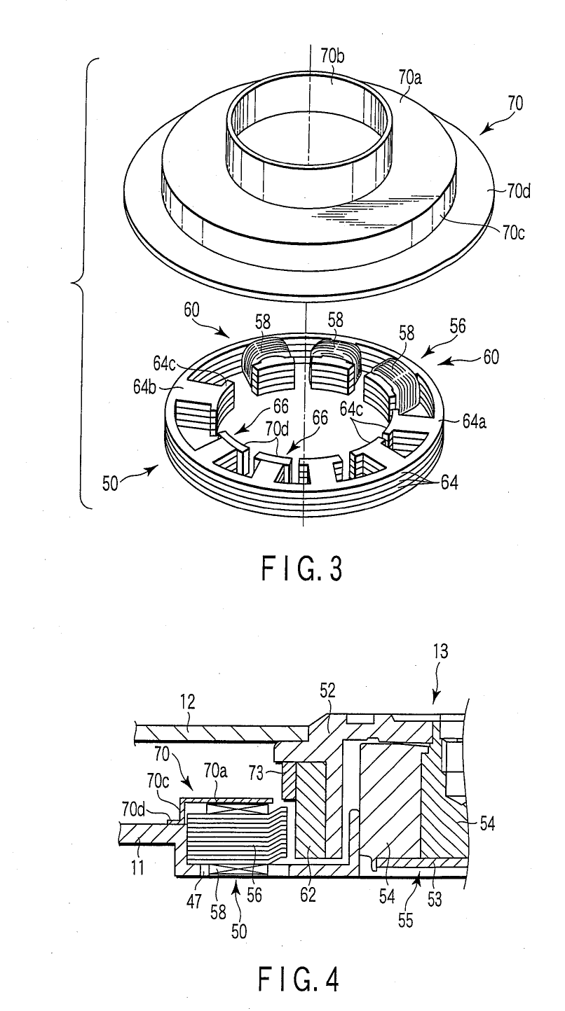

FIG. 2 shows a profile of the spindle motor 13 of the HDD, and FIG. 3 shows a stator and a magnetic shielding plate of the spindle motor.

As shown in FIGS. 2 and 3, the spindle motor 13 is provided with a rotor as a rotating body and a stator 50 as a stationary body. The spindle motor 13 is provided with a hub 52 that functions as a rotor and a spindle 54 fixed to the hub. The hub 52 is in the form of a closed-topped cylinder. The spindle 54 is fixed to the upper end portion of the hub and extends coaxially with the hub. The spindle 54 is supported for rotation with respect to the base 11 by a fluid bearing 55.

The fluid bearing 55 includes a cylindrical bearing sleeve 57 fixed to the base 11 and a thrust bearing plate 53 that closes a bottom opening of the sleeve. The spindle 54 is inserted through the sleeve 57 with a slight gap on its outer surface side. A gap between the inner surface of the sleeve 57 and the outer peripheral surface of the spindle 54 and a gap between the lower end surface of the spindle and the thrust bearing plate 53 are filled with a fluid, such as a lubricant. Further, a dynamic pressure generating groove, e.g., a herringbone groove, is formed on the outer peripheral surface of the spindle 54. This groove generates a dynamic pressure in the radial direction as the spindle rotates. Another dynamic pressure generating groove that generates a dynamic pressure in the thrust direction is formed on the lower end surface of the spindle.

A cylindrical magnet 62 is fixed on the outer peripheral surface of the hub 52 and situated coaxially with the spindle 54. The magnet 62 is exposed on the outer peripheral surface of the hub 52 and extends axially from the upper end portion to the lower end of the hub 52. The magnet 62 has a plurality of north and south poles that are formed alternately and at regular intervals in its circumferential direction. An annular flange 65 is formed integrally on the upper end portion of the outer peripheral surface of the hub 52. Further, the magnetic disk 12 is coaxially fitted around the upper end of the hub 52 and in contact with the flange 65.

The stator 50 is substantially annular. It is fixed coaxially with the spindle 54 on the base 11 and provided along the circumferential direction outside the hub 52. The stator 50 includes a core 56, which is formed by laminating metal plates 64, and coils 58 wound on the core. The core and the coils form a plurality of magnetic poles 60. These magnetic poles 60 are provided at regular intervals in the circumferential direction and opposed to the magnetic poles of the magnet 62.

Each of the metal plates 64 that constitute the core 56 is provided integrally with an arcuate frame portion 63a, coil support portions 64b extending from the frame portion toward its center, and arcuate retaining portions 64c formed individually on the respective extended ends of the coil support portions. Each metal plate 64 is formed of a magnetic material, e.g., an electromagnetic steel plate. Each of the coils 58 is wound on each combination of the laminated corresponding coil support portions 64b.

A circular recess 46 is formed in the bottom wall of the base 11, and the stator 50 is disposed in the recess 46. The stator 50 is located in a predetermined position such that its outer peripheral surface is in engagement with a stepped portion 46a that defines the recess 46. Thus, the retaining portions 64c of the core 56 adjacently face a substantially lower half region of the outer peripheral surface of the magnet 62.

In the recess 46, moreover, a plurality of openings 47 are formed in the bottom wall of the base 11. That end portion of each coil 58 of the stator 50 which is situated on the side of the base 11 is located in its corresponding opening 47.

As shown in FIGS. 2 and 3, the spindle motor 13 is provided with a magnetic shielding member for blocking leakage flux from a magnetic circuit that includes the magnet 62 and the stator 50. In the present embodiment, the magnetic shielding member is formed of a magnetic shielding plate 70. The magnetic shielding plate 70 is formed of a magnetic plate, e.g., a stainless-steel plate. The shielding plate 70 integrally includes a flat annular portion 70a, a cylindrical portion 70b, a cylindrical outer peripheral portion 70c, and an annular flange portion 70d. The cylindrical portion 70b extends upward from the inner peripheral edge of the annular portion. The outer peripheral portion 70c extends downward from the outer peripheral edge of the annular portion. The flange portion 70d extends from the lower end edge of the outer peripheral portion. The annular portion 70a, cylindrical portion 70b, outer peripheral portion 70c, and flange portion 70d are formed coaxially with one another. The cylindrical portion 70b and the outer peripheral portion 70c extend at right angles to the annular portion 70a.

The magnetic shielding plate 70 is coaxially arranged on the outer peripheral side of the hub 52 in a manner such that its flange portion 70d or annular portion 70a is fixed to the bottom surface of the base 11 or the coils 58. The annular portion 70a extends at right angles to the axis of rotation of the hub 52 and covers the upper surface portion of the stator 50. The cylindrical portion 70b extends upward along the direction of the rotation axis of the hub 52 and adjacently faces and covers the upper half of the magnet 62 from outside. Thus, the cylindrical portion 70b radially faces the whole outer peripheral surface of the hub 52 except a region where the stator 50 and the magnet 62 face each other.

The outer peripheral portion 70c of the magnetic shielding plate 70 adjacently faces the outer peripheral surface of the stator 50 and covers the outer peripheral portion of the stator.

According to the HDD constructed in this manner, the stator core of the spindle motor 13 can be made large, and the magnet 62 can be increased in size so that its length is substantially equal to the axial length of the hub 52. Thus, the area of opposite regions of the magnet 62 and the stator 50, which constitute the magnetic circuit, can be increased, so that the torque of the motor can be improved. The torque of the motor can be further improved by enhancing the magnetization on the side of the magnet 62, that is, by increasing saturated magnetization. If a magnet of the same material is used, it is advantageous to increase its volume, as in the present embodiment. In the case of the stator, an increase of its size results in an increase in the thickness or number of the laminated plates. Thus, based on the improvement of the torque of the spindle motor 13, there may be provided a spindle motor that can be stably used in a wide temperature range, including a low-temperature environment, and a disk device provided with the same.

If the stator 50 and the magnet 62 are large, moreover, the leakage flux from the magnetic circuit can be satisfactorily blocked to prevent its adverse influence on the magnetic disk 12 by covering the stator and the magnet with the annular portion 70a, cylindrical portion 70b, and outer peripheral portion 70c of the magnetic shielding plate 70. Thus, there may be provided a spindle motor with its magnetic circuit increased in size without failing to suppress the leakage flux and a disk device provided with the same.

The following is a description of an HDD provided with a spindle motor according to a second embodiment of the invention.

According to the second embodiment, as shown in FIG. 4, a magnetic shielding member of a spindle motor 13 is composed by combining a magnetic shielding plate and a shielding ring. A magnetic shielding plate 70 is formed of a magnetic plate, e.g., a stainless-steel plate. The shielding plate 70 is constructed in the same manner as that of the first embodiment except for the cylindrical portion. In other words, the shielding plate 70 integrally includes a flat annular portion 70a, a cylindrical outer peripheral portion 70c, and an annular flange portion 70d. The outer peripheral portion 70c extends downward from the outer peripheral edge of the annular portion. The flange portion 70d extends from the lower end edge of the outer peripheral portion.

The magnetic shielding plate 70 is coaxially arranged on the outer peripheral side of a hub 52 in a manner such that its flange portion 70d or annular portion 70a is fixed to the bottom surface of a base 11 or coils 58. The annular portion 70a extends at right angles to the axis of rotation of the hub 52 and covers the upper surface portion of a stator 50. The outer peripheral portion 70c adjacently faces the outer peripheral surface of the stator 50 and covers the outer peripheral portion of the stator.

A shielding ring 73 is a cylindrical structure that is formed of a magnetic material, such as stainless steel. The ring 73 is fixed to the outer peripheral surface of the upper half of the magnet 62 and covers the upper half of the magnet 62. More specifically, the ring 73 constitutes the cylindrical portion 70b of the magnetic shielding member, which radially faces the whole outer peripheral surface of the hub 52 except a region where the stator 50 and the magnet 62 face each other.

Since other configurations of the HDD of the second embodiment are the same as those of the foregoing first embodiment, like reference numbers are used to designate like portions, and a detailed description of those portions is omitted. Also in the second embodiment arranged in this manner, as in the foregoing first embodiment, there may be provided a spindle motor with its magnetic circuit increased in size without failing to suppress leakage flux from the magnetic circuit and a disk device provided with the same.

The following is a description of an HDD provided with a spindle motor according to a third embodiment of the invention. Only those portions which are different from their counterparts in the first embodiment will now be described in detail. Like reference numbers are used to designate like portions of the two embodiments, and a detailed description of those portions is omitted.

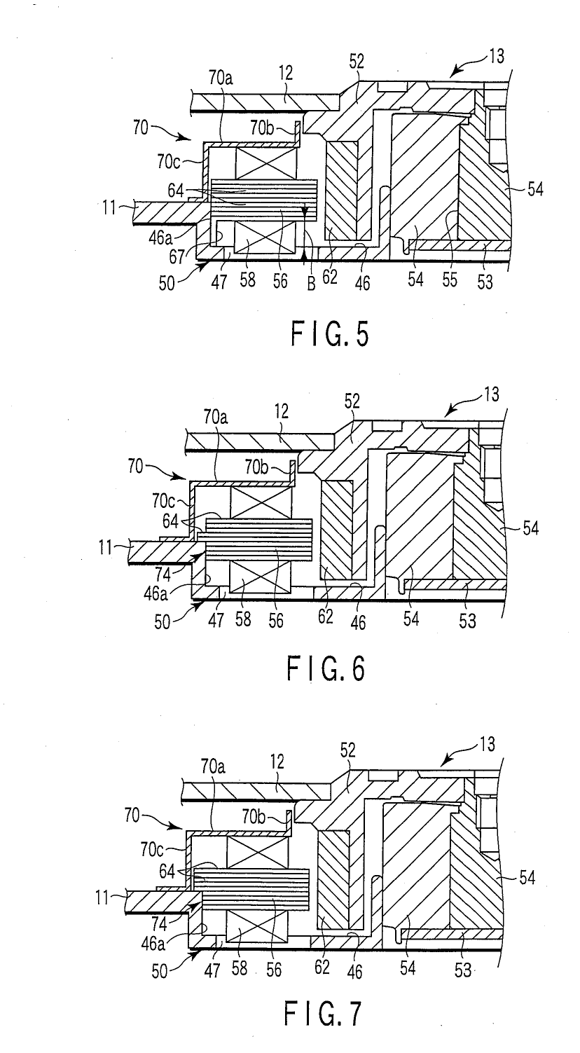

According to the third embodiment, as shown in FIG. 5, a stator 50 is provided with a core 56, which is constructed by laminating metal plates 64, and coils 58 wound on the core. That metal plate 64 which is situated in a lower layer, e.g., the lowermost layer, of the core 56 has its outer peripheral portion bent toward a base 11 of a housing 10 and forms a positioning piece 67. The stator 50 is located in a predetermined position such that its outer peripheral surface and the positioning piece 67 are in engagement with a stepped portion 46a that defines a recess 46 and that an extended end of the positioning piece 67 is in contact with the bottom surface of the recess 46.

Thus, the core 56 is fixedly positioned so that a gap B is formed between its lower surface and the bottom surface of the recess 46 or the bottom surface of the base 11. The core 56 adjacently faces an axially central part of the outer peripheral surface of a magnet 62.

A magnetic shielding plate 70 is formed of a magnetic plate, e.g., a stainless-steel plate. The shielding plate 70 integrally includes a flat annular portion 70a, a cylindrical portion 70b, a cylindrical outer peripheral portion 70c, and an annular flange portion 70d. The cylindrical portion 70b extends upward from the inner peripheral edge of the annular portion. The outer peripheral portion 70c extends downward from the outer peripheral edge of the annular portion. The flange portion 70d extends from the lower end edge of the outer peripheral portion. The magnetic shielding plate 70 is coaxially arranged on the outer peripheral side of a hub 52 in a manner such that its flange portion 70d or annular portion 70a is fixed to the bottom surface of the base 11 or the coils 58. The annular portion 70a extends at right angles to the axis of rotation of the hub 52 and covers the upper surface portion of the stator 50. The cylindrical portion 70b extends upward along the direction of the rotation axis of the hub 52 and radially faces the whole outer peripheral surface of the hub 52 except for a region where the stator 50 and the magnet 62 face each other. The outer peripheral portion 70c adjacently faces the outer peripheral surface of the stator 50 and covers the outer peripheral portion of the stator.

Also in the third embodiment arranged in this manner, as in the foregoing first embodiment, there may be provided a spindle motor with its magnetic circuit increased in size without failing to suppress leakage flux from the magnetic circuit and a disk device provided with the same. Since the core 56 of the spindle motor 13 is provided with the positioning piece 67, moreover, the linkage between the base 11 and the stator 50 can be strengthened, and the mounting position of the core 56 can be raised to form the gap B between its lower surface and the bottom surface of the base. In this case, a region that can be used as an accommodation space for the coils 58 can be widened. Thus, the coil winding diameter can be increased to reduce the resistance, or the number of coil windings can be increased. In consequence, the motor torque can be increased to improve the motor characteristics. The stator mounting position can be freely set with use of common components without changing the external shape of the HDD.

According to a fourth embodiment shown in FIG. 6, a stepped portion is formed as a core fixing structure on the outer peripheral portion of a core 56. More specifically, the outside diameter of at least those metal plates which are situated above the lowermost layer with respect to the stacking direction, e.g., metal plates in intermediate layers, out of metal plates 64 that constitute the core 56 of a stator 50, is made larger than that of those metal plates which are situated lower than the intermediate ones. Thus, the intermediate metal plates, in conjunction with the metal plates below them, form a stepped portion 74. The stator 50 is located in a predetermined position such that the stepped portion 74 of the core 56 is in engagement with a stepped portion 46a that defines a recess 46 of a base 11. Thus, the core 56 is fixedly positioned so that a gap is formed between its lower surface and the bottom surface of the recess 46 or the bottom surface of the base 11. The core 56 adjacently faces an axially central part of the outer peripheral surface of a magnet 62.

According to a fifth embodiment shown in FIG. 7, the outside diameter of those metal plates which are situated in an upper layer portion with respect to the stacking direction, out of metal plates 64 that constitute a core 56 of a stator 50, is made larger than that of the other metal plates. Thus, the upper metal plates, in conjunction with the other metal plates, form a stepped portion 74. The stator 50 is located in a predetermined position such that the stepped portion 74 of the core 56 is in engagement with a stepped portion 46a that defines a recess 46 of a base 11. Thus, the core 56 is fixedly positioned so that a gap is formed between its lower surface and the bottom surface of the recess 46 or the bottom surface of the base 11. The core 56 adjacently faces an axially central part of the outer peripheral surface of a magnet 62.

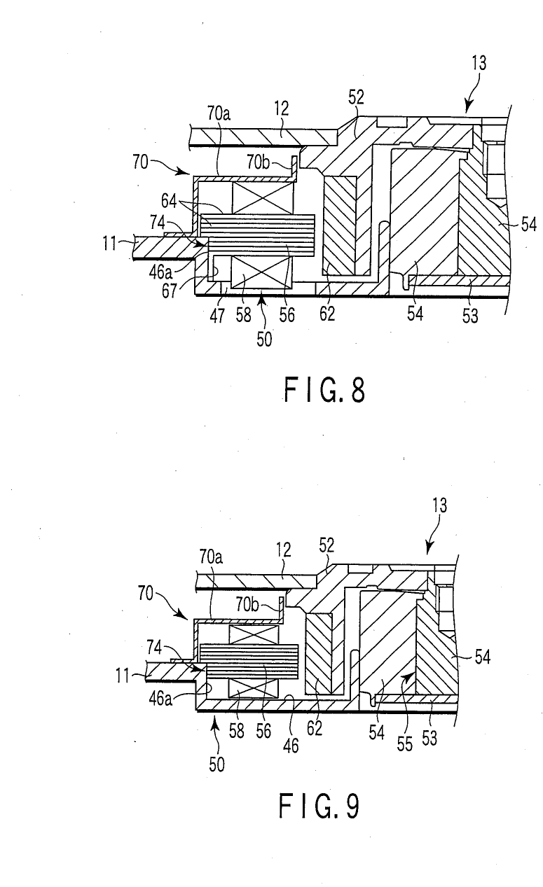

According to a sixth embodiment shown in FIG. 8, the outside diameter of those metal plates which are situated in an upper layer portion with respect to the stacking direction, out of metal plates 64 that constitute a core 56 of a stator 50, is made larger than that of the other metal plates. Thus, the upper metal plates, in conjunction with the other metal plates, form a stepped portion 74. Further, that metal plate 64 which is situated in the lowermost layer of the core 56 has its outer peripheral portion bent toward a base 11 of a housing 10 and forms a positioning piece 67. The stator 50 is located in a predetermined position such that the stepped portion 74 of the core 56 is in engagement with a stepped portion 46a that defines a recess 46 of the base 11 and that an extended end of the positioning piece 67 is in contact with the bottom surface of the recess 46. Thus, the core 56 is fixedly positioned so that a gap is formed between itself and the bottom surface of the base 11. The core 56 adjacently faces an axially central part of the outer peripheral surface of a magnet 62.

Since other configurations of the spindle motor 13 including the magnetic shielding plate 70 according to each of the fourth, fifth, and sixth embodiments are the same as those of the third embodiment, like reference numbers are used to designate like portions, and a detailed description of those portions is omitted. The same functions and effects of the third embodiment can be also obtained from the fourth, fifth, and sixth embodiments.

In the third to sixth embodiments described above, the gap that can accommodate the coils can be provided between the lower surface of the stator 50 and the bottom surface of the base 11. As shown in FIG. 9, therefore, the coil accommodation openings 47 formed in the bottom wall of the base 11 may be omitted. In this case, the stiffness of the entire housing 10 can be increased, so that the yield strength of the HDD against vibration and shock can be improved.

In generating an axial force in the hub 52 as required, according to the spindle motor 13 described above, moreover, the magnet and the stator core 56 are located with their respective axial directions shifted for a predetermined amount, as shown in FIG. 5, for example. By doing this, the hub can be subjected to a force that is optionally controlled as a magnetically generated force.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the magnetic disk device of this invention is not limited to use with 2.5-inch-diameter disks but may also be applied to disks of any other diameter, such as 1 or 1.8 inches. The numbers of magnetic disks and magnetic heads are not limited to the ones described in connection with the foregoing embodiments, but may be increased or reduced as required. Further, the materials of the various components, including the housing, core, magnetic shielding plate, etc., are not limited to the embodiments described herein, but may be selected variously.

What is claimed is:

1. A spindle motor comprising:
a rotor;
a fluid bearing which is provided on a base and supports the rotor for rotation;
a cylindrical magnet coaxially fixed to the rotor, exposed on an outer peripheral surface of the rotor, and having a plurality of magnetic poles arranged side by side in a circumferential direction;
an annular stator fixed to the base, located outside the rotor in the circumferential direction, and having a plurality of magnetic poles opposed to the magnet of the rotor; and
a magnetic shielding member which blocks leakage flux from a magnetic circuit, the magnetic shielding member including an annular portion which extends at right angles to an axis of rotation of the rotor and covers an upper surface portion of the stator and a cylindrical portion which extends along the axis of rotation of the rotor and radially faces the whole outer peripheral surface of the rotor except a region where the stator and the magnet face each other.

2. A spindle motor according to claim 1, wherein the magnetic shielding member includes a shielding plate which is provided integrally with the annular portion and the cylindrical portion and formed of a magnetic plate, and the cylindrical portion extends along the axis of rotation of the rotor from the inner peripheral side of the annular portion.

3. A spindle motor according to claim 1, wherein the magnetic shielding member includes a shielding plate which is formed of a magnetic plate and constitutes the annular portion and a shielding ring which is fixed to the whole outer peripheral surface of the magnet except the region where the stator and the magnet face each other and constitutes the cylindrical portion.

4. A spindle motor according to claim 2, wherein the shielding plate includes an outer peripheral portion which extends in the axial direction of the rotor and faces an outer peripheral surface of the stator.

5. A spindle motor according to claim 1, wherein the stator includes a core constructed by laminating a plurality of metal plates and a plurality of coils wound on the core, that metal plate which is situated in a lower layer of the core including a positioning piece which is bent toward the base and engages the base to position the stator.

6. A spindle motor according to claim 1, wherein the stator includes a core constructed by laminating a plurality of metal plates and a plurality of coils wound on the core, the outside diameter of at least those metal plates which are situated above the lowermost layer with respect to a stacking direction, out of the plurality of metal plates, being larger than that of those metal plates which are situated lower than the above-situated metal plates, so that the above-situated metal plates, in conjunction with the lower metal plates, form a stepped portion which engages the base to position the stator.

7. A spindle motor according to claim 5, wherein the base has a plurality of openings which face the stator and accommodate the coils, individually.

8. A disk device comprising:
a housing including a base;
a disk-shaped recording medium arranged in the housing;
a spindle motor which is provided on the base and supports and rotates the recording medium;
a head which records and reproduces information to and from the recording medium; and
a head actuator which is disposed in the housing, supports the head for movement, and moves the head with respect to the recording medium,
the spindle motor including a rotor, a fluid bearing which is provided on the base and supports the rotor for rotation, a cylindrical magnet coaxially fixed to the rotor, exposed on an outer peripheral surface of the rotor, and having a plurality of magnetic poles arranged side by side in a circumferential direction, an annular stator fixed to the base, located outside the rotor in the circumferential direction, and having a plurality of magnetic poles opposed to the magnet of the rotor, and a magnetic shielding member which blocks leakage flux from a magnetic circuit, the magnetic shielding member including an annular portion which extends at right angles to an axis of rotation of the rotor and covers an upper surface portion of the stator and a cylindrical portion which extends along the axis of rotation of the rotor and radially faces the whole outer peripheral surface of the rotor except a region where the stator and the magnet face each other.

9. A disk device according to claim 8, wherein the head actuator is provided with a bearing portion supported on the base and a suspension which is rockably supported by the bearing portion, extends from the bearing portion, and supports the magnetic head.

10. A disk device according to claim 8, wherein the spindle motor is provided with a spindle supported by the fluid bearing and a hub which is fixed to the spindle and constitutes the rotor, and the recording medium is fixed to the hub and held coaxially with the spindle.

11. A disk device according to claim 8, wherein the magnetic shielding member includes a shielding plate which is provided integrally with the annular portion and the cylindrical portion and formed of a magnetic plate, and the cylindrical portion extends along the axis of rotation of the rotor from the inner peripheral side of the annular portion.

12. A disk device according to claim 8, wherein the magnetic shielding member includes a shielding plate which is formed of a magnetic plate and constitutes the annular portion and a shielding ring which is fixed to the whole outer peripheral surface of the magnet except the region where the stator and the magnet face each other and constitutes the cylindrical portion.

13. A disk device comprising:
a housing including a base;
a disk-shaped recording medium disposed in the housing;
a spindle motor which is provided on the base and supports and rotates the recording medium;
a head which records and reproduces information to and from the recording medium; and
a head actuator which is disposed in the housing, supports the head for movement, and moves the head with respect to the recording medium,
the spindle motor including a rotor, a fluid bearing which is provided on the base and supports the rotor for rotation, a cylindrical magnet coaxially fixed to the rotor, exposed on an outer peripheral surface of the rotor, and having a plurality of magnetic poles arranged side by side along a circumferential direction, an annular stator fixed to the base, located outside the rotor along the circumferential direction, and having a plurality of magnetic poles opposed to the magnet of the rotor, and a magnetic shielding member which is provided covering the stator and the magnet and blocks leakage flux from a magnetic circuit,
the stator including a core constructed by laminating a plurality of metal plates and a plurality of coils wound on the core, that metal plate which is situated in a lower layer of the core including a positioning piece which is bent toward the base and engages the base to position the stator.
